(19) United States
(12) Patent Application Publication
(10) Pub. No.: US 2026/0051923 A1
(43) Pub. Date: Feb. 19, 2026

(54) DATA STREAM CANCELLATION FOR DATA TRANSMISSION NETWORK

(71) Applicant: SONY GROUP CORPORATION, TOKYO (JP)

(72) Inventor: BERNARD JAMES GRIFFITHS, BEN LOMOND, CA (US)

(21) Appl. No.: 18/808,488

(22) Filed: Aug. 19, 2024

(51) Int. Cl. H04B 3/23

(52) U.S. Cl. CPC H04B 3/23

(57) ABSTRACT

A data canceler is disclosed herein. The data canceler includes a first inverter circuit. The first inverter circuit is configured to generate a first inverted data signal based on an inversion of a first unwanted data signal supplied via a first input terminal of a data transmission network. The data canceler includes a passive network comprising a plurality of passive components arranged between an output terminal of the transmission network and an output of the first inverter circuit. The passive network is configured to receive, via the output terminal of the transmission network, a mixed data signal comprising a target data signal and the first unwanted data signal, and further combine the first inverted data signal and the mixed data signal across the passive components to cancel the first unwanted data signal in the mixed data signal.

### FIELD

Various embodiments of the disclosure relate to the field of noise cancellation and data transmission. More specifically, various embodiments of the disclosure relate to data stream cancellation for a data transmission network.

### BACKGROUND

Data communication, also known as Digital communication, involves the transmission and reception of digital or analog data through various mediums such as cables, optical fibers, or wireless signals. This form of communication is integral to daily life, facilitating activities such as sending and receiving emails, answering phone calls, video conferencing, streaming services, and more, thereby enabling global engagement across devices. However, during transmission, undesirable or unwanted signals, commonly referred to as ‘Noise’, may randomly interfere with the actual information-carrying signals. This inevitable phenomenon can cause disturbances in the original signal, leading to interference that adversely affects the quality of the transmitted data. This can result in errors in the communication system, reduced efficiency, and difficulties in demodulating the transmitted signals. In some cases, data communication may involve the incorporation of two or more data streams at different frequencies into one transmission line, making the extraction of the required data stream a complex task. Various techniques, such as the use of filters, have been employed in the past to eliminate noise or unwanted data streams from the transmitted signals. However, these techniques are often inefficient. Therefore, there is a need for a more efficient and advanced device capable of phasing out unwanted signals from the transmitted data. Additionally, enhanced minimization of noise or jitter in frequency synthesis applications is desirable.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A communication device and method for data stream cancellation for a data transmission network is provided substantially as shown in, and/or described in connection with, at least one of the figures, as set forth more completely in the claims.

These and other features and advantages of the present disclosure may be appreciated from a review of the following detailed description of the present disclosure, along with the accompanying figures, in which like reference numerals refer to like parts throughout.

### BRIEF DESCRIPTION OF THE DRAWINGS

FIG. 1 is a block diagram that illustrates an exemplary circuit diagram of data canceler, in accordance with an embodiment of the disclosure.

FIG. 2A shows a first exemplary circuit diagram of the data canceler designed for two input data signals of FIG. 1, in accordance with an embodiment of the disclosure.

FIG. 2B shows a second exemplary circuit diagram of the data canceler designed for two input data signals of FIG. 1, in accordance with an embodiment of the disclosure.

FIG. 3 shows an exemplary circuit diagram of the data canceler designed for three input data signals, in accordance with an embodiment of the disclosure.

FIG. 4 shows an exemplary circuit diagram of the data canceler designed for multiple input data signals, in accordance with an embodiment of the disclosure.

FIG. 5 shows an exemplary block diagram of a communication device equipped with the data canceler designed for multiple input data signals, in accordance with an embodiment of the disclosure.

FIG. 6 illustrates a flowchart that illustrates a data cancellation method, in accordance with an embodiment of the disclosure.

### DETAILED DESCRIPTION

The following described implementations may be found in the disclosed data canceler, communication device, and data cancellation method. Exemplary aspects of the disclosure may provide a data canceler, which includes a first inverter circuit and a passive network. The first inverter circuit may include an input coupled to a first input terminal of a data transmission network. Further, the passive network may include a plurality of passive components arranged between an output terminal of the data transmission network and an output of the first inverter circuit. Based on an inversion of a first unwanted data signal supplied via the first input terminal, the first inverter circuit may be configured to generate a first inverted data signal. Further, the passive network may be configured to receive a mixed data signal via the output terminal of the data transmission network, where the mixed data signal may include a target data signal and the first unwanted data signal. Next, the passive network may be configured to combine the first inverted data signal and the mixed data signal across the plurality of passive components to cancel the first unwanted data signal in the mixed data signal.

Data communication generally requires two or more data streams at different frequencies to be incorporated into one transmission line. At least one of them may include information to be transmitted, and other may act as carrier, which may be of pre-defined frequencies and carry the information to be transmitted from one end (transmitter) to another end (receiver). Many a times, extracting the required data stream at the receiver's end can be quite challenging and complex.

Various techniques have been utilized in the past to extract the required data by eliminating the noise or unwanted data streams of different frequencies from the transmitted signals. For instance, filters have been incorporated in existing communication systems and networks to filter the desired data from the combined data streams, but it is usually not an efficient technique. Further, existing devices for data cancellation are also equipped with other such elements, such as slicer, DAC, ADC, CDR, timer, which makes such devices quite complex and costly as well.

The data canceler of the present disclosure may provide an efficient and easy framework for data cancellation. In order to do so, the data canceler may receive first unwanted data as an input from a first input terminal of a data transmission network. The data canceler may include a first inverter circuit, whose input may be coupled to the first input terminal of the data transmission network. The first inverter circuit may be configured to generate a first inverted data signal based on an inversion of first unwanted data signal supplied via the first input terminal. The data canceler may further include a passive network comprising a plurality of passive components, such as resistors or capacitors, arranged between an output terminal of the data transmission network and an output of the first inverter circuit. Further, the passive network may be configured to receive, via the output terminal of the data transmission network, a mixed data signal including a target data signal and the first unwanted data signal. The data canceler may further combine the first inverted data signal and the mixed data signal across the plurality of passive components, which results in cancellation of the first unwanted data signal in the mixed data signal. The disclosed data canceler may thereby provide desired signal as output by enabling cancellation of unwanted data in an efficient and easy manner. Therefore, the disclosed data canceler may be incorporated in communication devices, systems, and communication networks to facilitate efficient communication by cancelling unwanted data from the mixed data signal, and hence transmitted data containing requisite information can be easily demodulated at receiver's end.

The disclosed data canceler and method offer potential advantages over these traditional methods. By simply adding the combined signals with the inverted data of the unwanted data stream and applying the inverted unwanted stream through a series of resistors or capacitors, the unwanted data stream may be cancelled. This approach may provide a simpler and more effective solution for data stream cancellation. Furthermore, the disclosed data canceler and method may be adaptable to different data signal amplitudes by adjusting the ratio of the passive components in the same proportion as the ratio of the incoming amplitudes. By adjusting the ratio of the passive components, the method may accommodate varying signal amplitudes, ensuring precise cancellation of unwanted data signals regardless of their amplitude. This adaptability may potentially lead to more accurate data extraction, further enhancing the quality of the extracted data stream. In summary, the disclosed data canceler and method may provide a simpler, more effective, and adaptable solution for data stream cancellation, potentially offering improved performance over traditional methods.

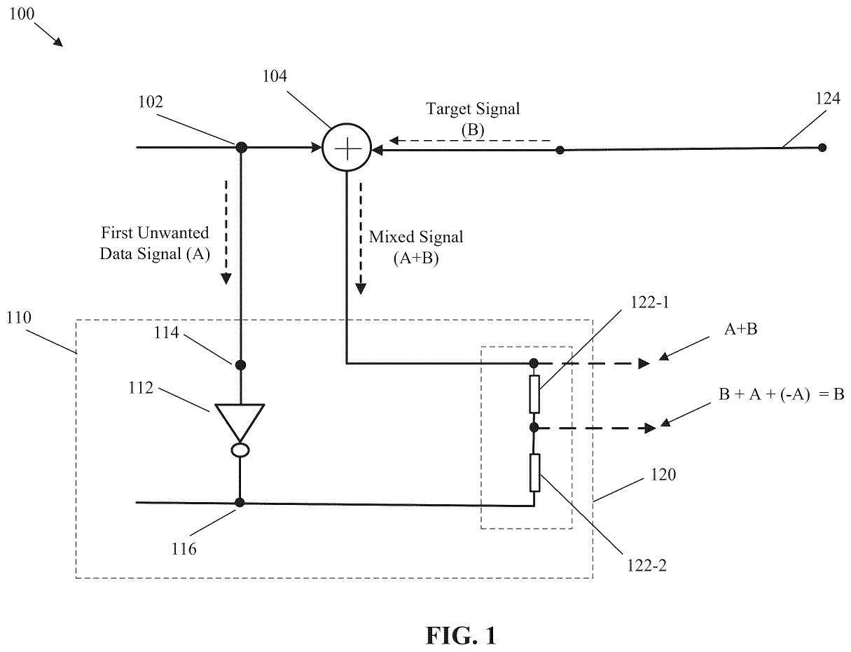

FIG. 1 is a block diagram that illustrates an exemplary circuit diagram of data canceler, in accordance with an embodiment of the disclosure. With reference to FIG. 1, there is shown a data transmission network 100, which may be configured to receive and transmit more than one data signal synchronously at a time. The data transmission network 100 may refer to a network that may allow transfer of data and data signals between various devices, locations, transmission lines, or systems. Here, the data transmission network 100 may include a transmission line 124, through which a target signal, for instance signal B, may be transmitted. The transmission line 124 may be coupled to an output terminal 104 of the data transmission network 100. The data transmission network 100 may include a data canceler 110 for cancellation of unwanted data signals, so that desired signals may be generated as output.

The data canceler 110 may include a first inverter circuit 112, which may further include suitable logic, circuitry, and interfaces, and/or code that may be configured to enable cancellation of unwanted data signals, thereby providing desired signals as output at receiver's end. The first inverter circuit 112 may include an input 114 (also referred to as input terminal 114, herein), which may be coupled to a first input terminal 102 of the transmission line 124 of the data transmission network 100. The input terminal 114 may be coupled to the first input terminal 102 such that wires or links associated with the first input terminal 102 should get coupled with wires or links of same polarity associated with the input terminal 114.

In operation, the first inverter circuit 112 may be configured to generate a first inverted data signal (−A) based on an inversion of a first unwanted data signal (A) supplied via the first input terminal 102.

The data canceler 110 may further include a passive network 120, which may in turn include a multitude of passive components 122 arranged between the output terminal 104 of the data transmission network 100 and an output 116 (also, referred to as output terminal 116, herein) of the first inverter circuit 112. In a preferred embodiment, the passive components 122 may include a first passive component 122-1 and a second passive component 122-2, such that the first passive component 122-1 may be arranged between the output terminal 104 of the data transmission network 100 and the second passive component 122-2. Further, the second passive component 122-2 may be arranged between the first passive component 122-2 and the output terminal 116 of the first inverter circuit 112. In an exemplary embodiment, each passive component of the plurality of passive components 122 may be a resistor or a capacitor. In another exemplary embodiment, each passive component of the plurality of passive components 122 may be a variable resistor or a variable capacitor.

In operation, the passive network 120 may be configured to communicate with the output terminal 104 of the data transmission network 100 and receive a mixed data signal (A+B) including the target data signal (B) and the first unwanted data signal (A). Further, the passive network 120 may combine the first inverted data signal (−A) and the mixed data signal (A+B) across the passive components 122 to cancel the first unwanted data signal (A) in the mixed data signal (A+B). The cancellation of the first unwanted data signal (A) in the mixed data signal (A+B) may produce the target data signal (B) across the second passive component 122-2.

In an exemplary embodiment, a ratio of resistance or capacitance values of the first passive component 122-1 to that of the second passive component 122-2 may be equal to a ratio of an amplitude of the mixed data signal (A+B) to an amplitude of the first inverted data signal (−A). The ratio of resistance or capacitance values of the first passive component 122-1 to that of the second passive component 122-2 plays a key role in determining signal-to-noise ratio. Hence, when the ratio of resistance or capacitance values of the first passive component 122-1 to that of the second passive component 122-2 is adjusted to be equal to the ratio of the amplitude of the mixed data signal (A+B) to the amplitude of the first inverted data signal (−A), the passive network 120 may efficiently cancel out the noise, here the first unwanted signal (A).

In operation, a resistance of the first passive component 122-1 may be greater than an output impedance of the data canceler 110. Moreover, a canceler output swing voltage associated with the first inverter circuit 112 may depend on a voltage of a main driver of the data canceler 110.

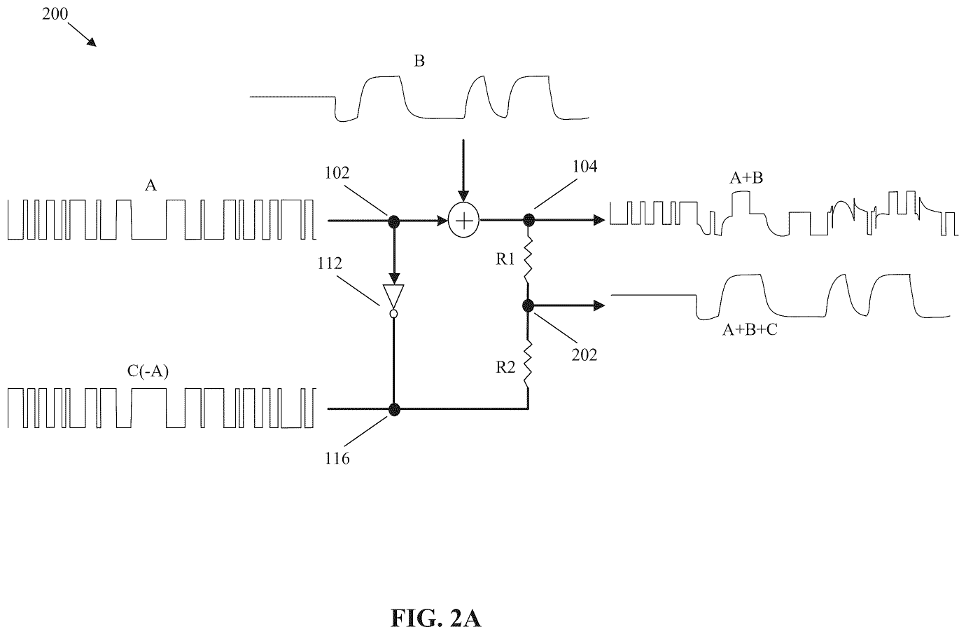

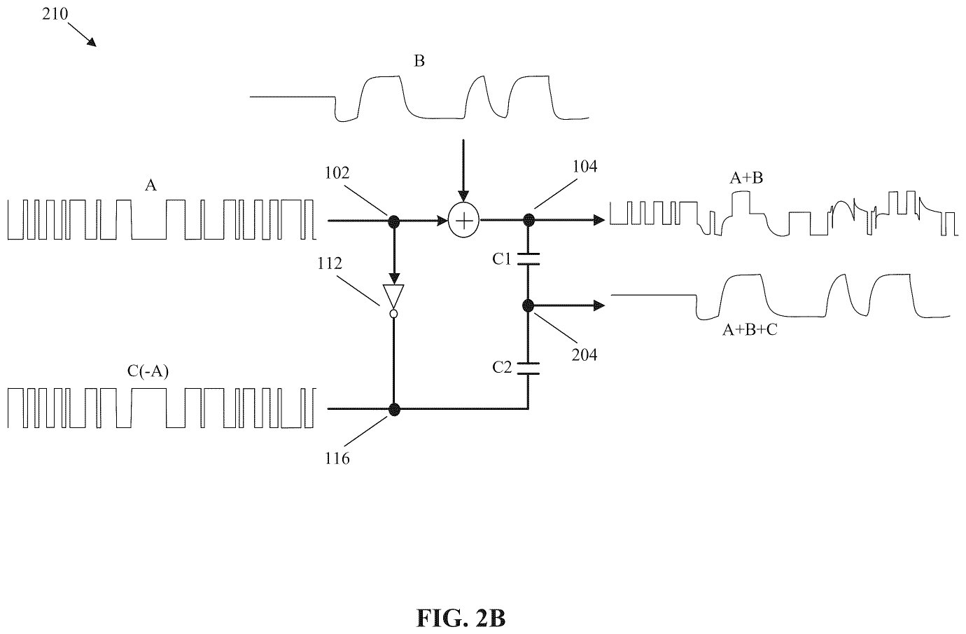

FIG. 2A shows a first exemplary circuit diagram 200 of the data canceler designed for two input data signals of FIG. 1, in accordance with an embodiment of the disclosure. FIG. 2A is described in conjunction with elements from FIG. 1. With reference to FIG. 2A, there is shown the first exemplary circuit diagram 200 of the data canceler 110. The data canceler 110 may be integrated into the data transmission network 100, such that the data canceler 110 receives various data signals from the data transmission network 100, mixes the received data signals, and further cancels unwanted data signals from the mixed data signals. For instance, as shown, the data canceler 110 may receive a data signal A and a data signal B, where the data signal B may be the target data signal and the data signal A may be the unwanted data signal. The first inverter circuit 112 may be configured to generate an inverted data signal C based on an inversion of the unwanted data signal A supplied via the first input terminal 102 or the second input terminal 106, respectively. Further, the passive network 120 may include two resistors ‘R1’ and ‘R2’, and the passive network 120 may receive, via the output terminal 104 of the data transmission network 100, a mixed data signal (A+B) that includes the target data signal B and the unwanted data signal A. The passive network 120 may then combine the inverted data signal C and the mixed data signal (A+B) across the resistor ‘R2’ to cancel the unwanted data signal A in the mixed data signal (A+B), and hence, the target data signal B may be extracted easily at node 202.

Even if the two signals (A+B and C) are of different amplitudes, cancellation may still be achieved by changing the ratio of ‘R1’ and ‘R2’ in the same proportion as the ratio of amplitudes of the two incoming data signals, i.e., A+B and C.

FIG. 2B shows a second exemplary circuit diagram 210 of the data canceler designed for two input data signals of FIG. 1, in accordance with an embodiment of the disclosure. FIG. 2B is described in conjunction with elements from FIG. 1 and FIG. 2A. With reference to FIG. 2B, there is shown the second exemplary circuit diagram 210 of the data canceler 110. Here, the passive network 120 may include two capacitors ‘C1’ and ‘C2’. The passive network 120 may combine the first inverted data signal C and the mixed data signal (A+B) across the capacitor ‘C2’ to cancel the unwanted data signal A in the mixed data signal (A+B), and thus, the target data signal B may be extracted easily at node 204. Moreover, the two signals (A+B and C) are of different amplitudes, cancellation may still be achieved by changing the ratio of ‘C1’ and ‘C2’ in the same proportion as the ratio of amplitudes of the two incoming data signals, i.e., A+B and C.

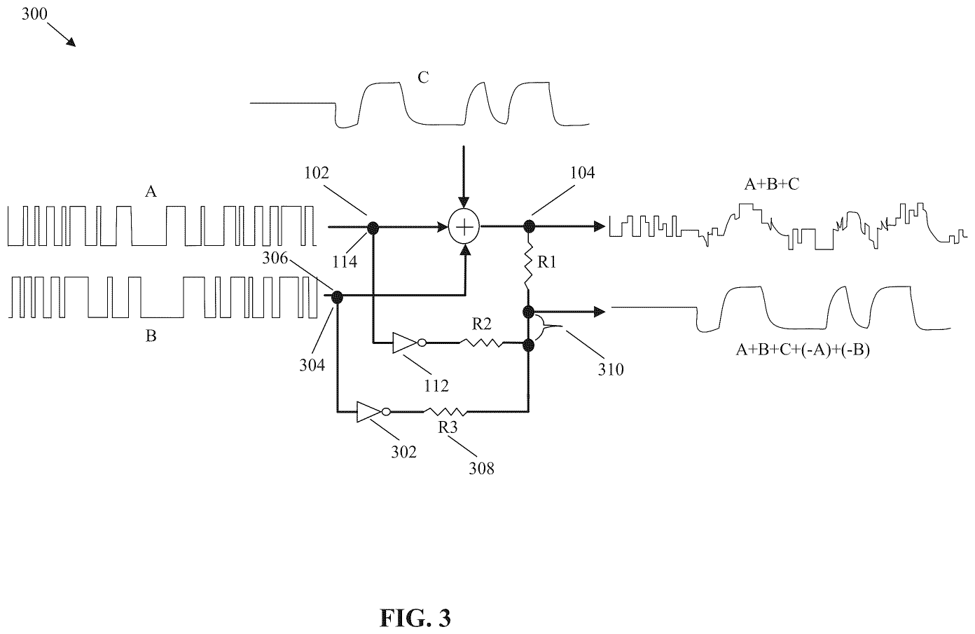

FIG. 3 shows an exemplary circuit diagram of the data canceler designed for three input data signals, in accordance with an embodiment of the disclosure. FIG. 3 is described in conjunction with elements from FIG. 1, FIG. 2A, and FIG. 2B. With reference to FIG. 3, there is shown the exemplary circuit diagram 300 of the data canceler 110. The data canceler 110 may be integrated into the data transmission network 100, such that the data canceler 110 may receive various data signals from the data transmission network 100, mix the received data signals, and may further cancel unwanted data signals from the mixed data signals. As shown, for instance, the data canceler 110 may receive a data signal A, a data signal B, and a data signal C, where the data signal C may be the target data signal and the data signals A and B may be unwanted data signals. The data canceler 110 may include two inverter circuits, i.e., a first inverter circuit 112 and a second inverter circuit 302.

In certain embodiments, the second inverter circuit 302 may include suitable logic, circuitry, and interfaces, and/or code that may be configured to enable cancellation of unwanted data signals, thereby providing desired signals. The second inverter circuit 302 may include an input 304 (also, referred to as input terminal 304, herein), which may be coupled to a second input terminal 306 of the data transmission network 100. The input terminal 304 may be electronically coupled to the second input terminal 306.

In operation, the second inverter circuit 302 may be configured to generate a second inverted data signal based on an inversion of a second unwanted data signal supplied via the second input terminal 306, so as to cancel out the second unwanted data signal from the mixed data signal.

The passive components may include a third passive component 308 arranged between an output (also, referred to as output terminal, herein) of the second inverter circuit 302 and the first passive component 122-1 connected to the output terminal 104 of the data transmission network 100.

The first inverter circuit 112 may be electrically connected to resistor ‘R2’, where the ‘R2’ may be further electrically connected to node 310 of the data canceler 110. The first inverter circuit 112 may be configured to generate an inverted data signal based on an inversion of the unwanted data signal A supplied via the first input terminal 102. The second inverter circuit 302 may be electrically connected to resistor ‘R3’, where the ‘R3’ may be further electrically connected to the node 310. The second inverter circuit 302 may be configured to generate an inverted data signal based on an inversion of the unwanted data signal B supplied via the second input terminal 106. Further, the passive network 120 may also include a resistor ‘R1’. The passive network 120 may receive, via the output terminal 104 of the data transmission network 100, a mixed data signal (A+B+C) comprising the target data signal C and the unwanted data signals A and B. The passive network 120 may next combine the inverted data signals associated with the unwanted data signals A and B, and the mixed data signal (A+B+C) across the resistor ‘R1’, which results in the cancellation of the unwanted data signals A and B in the mixed data signal (A+B+C). Hence, the target data signal C may be extracted at the node 310, through the cancellation, efficiently.

For sake of brevity, there is shown only two inverter circuits—the first inverter circuit 112 and the second inverter circuit 302 for canceling out first unwanted data signal and second unwanted data signal, respectively. However, the disclosure may not be so limited to two inverter circuits, and suitable number of two inverter circuits may be utilized for the cancellation of various unwanted data signals present in the mixed data signal, which is well within the scope of the disclosure. Further, the number of inverter circuits may be dependent on the number of unwanted data signals required to be canceled from the mixed data signal.

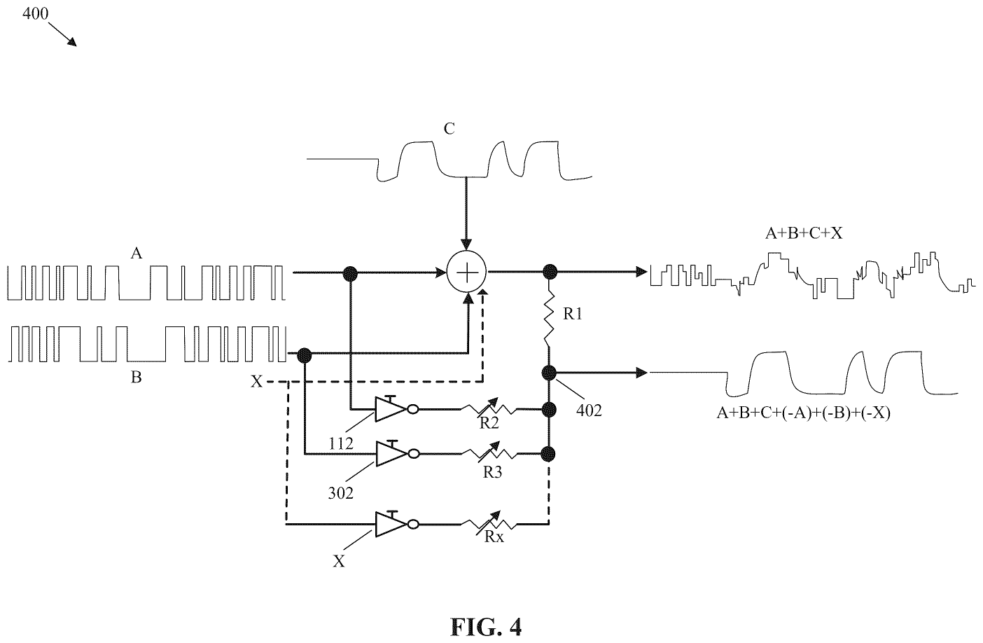

FIG. 4 is an exemplary circuit diagram of the data canceler designed for multiple input data signals, in accordance with an embodiment of the disclosure. FIG. 4 is described in conjunction with elements from FIG. 1, FIG. 2A, FIG. 2B, and FIG. 3. With reference to FIG. 4, there is shown the exemplary circuit diagram 400 of the data canceler 110. The data canceler 110 may be integrated into the data transmission network 100 so that the data canceler 110 receives a specific number of data signals (which may be denoted by ‘X’) from the data transmission network 100, mixes the received data signals, and further cancels unwanted data signals from the mixed data signals. For instance, as shown, the data canceler 110 may receive data signals A, B, C . . . X, where the data signal C may be the target data signal and the data signals A, B . . . X may be unwanted data signals. The data canceler 110 may include a specific number of inverter circuits, say ‘X’ inverter circuits. The first inverter circuit 112 may be electrically connected to resistor ‘R2’. The first inverter circuit 112 may be configured to generate an inverted data signal based on an inversion of the unwanted data signal A supplied via the first input terminal 102. The second inverter circuit 302 may be electrically connected to resistor ‘R3’, where the second inverter circuit 302 may be configured to generate an inverted data signal based on an inversion of the unwanted data signal B supplied via the second input terminal 106. Similarly, X^{th} inverter circuit (X) may be electrically connected to resistor ‘RX,’ where the inverter circuit X may be configured to generate an inverted data signal based on an inversion of the unwanted data signal X supplied via corresponding input terminal. Further, the passive network 120 may also include a resistor ‘R1’. The passive network 120 may receive, via the output terminal 104 of the data transmission network 100, a mixed data signal (A+B+C+ . . . X) including the target data signal C and the unwanted data signals A, B . . . X. The passive network 120 may combine the inverted data signals associated with the unwanted data signals A, B . . . X, and the mixed data signal (A+B+C+ . . . X) across the resistor ‘R1’ to cancel the unwanted data signals A, B . . . X in the mixed data signal (A+B+C+ . . . X), and thus, the target data signal C may be extracted efficiently at node 402. Values of the passive components 122 associated with the passive network 120, for instance, ‘R1’, ‘R2’, ‘R3’ . . . ‘RX’ may be varied by changing the respective resistance ratio of the resistors in the same proportion as the ratio of amplitudes of the incoming data signals. Further, voltage associated with each of the invertor circuits may also be varied in accordance with the ratio of amplitudes of the incoming data signals. In an instance, if the ratio of amplitudes of the incoming data signals for the first inverter circuit 112 and the second inverter circuit 302 is 3:1, then the value of the resistors ‘R2’ and ‘R3’ should be adjusted such that the ratio of the voltages across the first inverter circuit 112 and the second inverter circuit 302 may become 3:1.

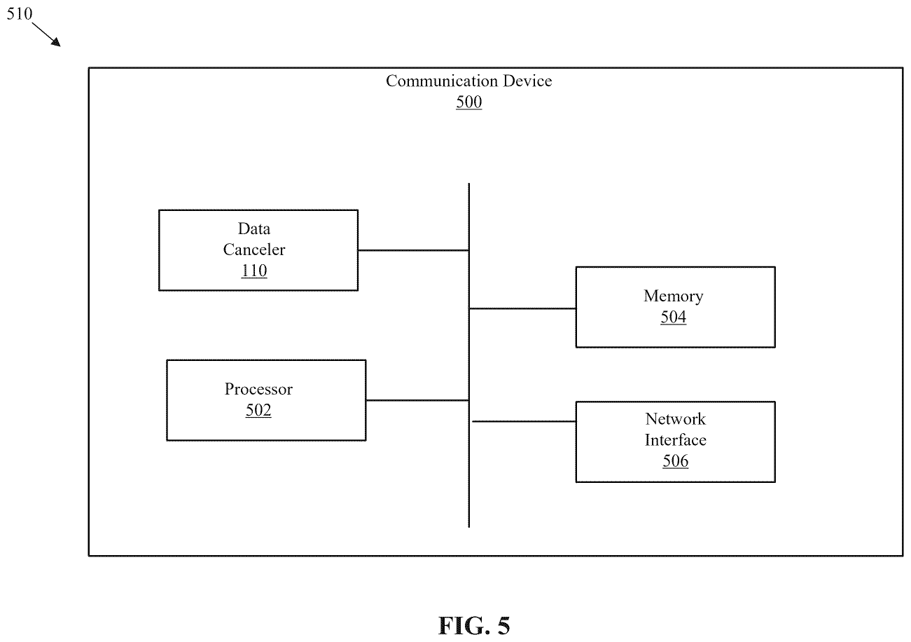

FIG. 5 shows an exemplary block diagram 510 of a communication device 500 equipped with the data canceler 110 designed for multiple input data signals, in accordance with an embodiment of the disclosure. FIG. 5 is described in conjunction with elements from FIG. 1, FIG. 2A, FIG. 2B, FIG. 3, and FIG. 4. With reference to FIG. 5, the communication device 500 may include a data canceler (say, the data canceler 110 of FIG. 1), a processor 502, a memory 504, and a network interface 506. The communication device 500 may be adapted to be coupled to the data transmission network 100 for facilitating transmission and receipt of data signals from a source point to an end point.

The processor 502 may include suitable logic, circuitry, and/or interfaces that may be configured to execute program instructions associated with different operations to be executed by the communication device 500. The operations may be configured to trigger activation of operations of the data canceler 110. The processor 502 may further be configured to store or read output of the data canceler 110, if required. The processor 502 may include one or more processing units, which may be implemented as a separate processor. In an embodiment, the one or more processing units may be implemented as an integrated processor or a cluster of processors that perform the functions of the one or more specialized processing units, collectively. The processor 502 may be implemented based on a number of processor technologies known in the art. Examples of implementations of the processor 502 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 504 may include suitable logic, circuitry, interfaces, and/or code that may be configured to store one or more instructions to be executed by the processor 502. The one or more instructions stored in the memory 504 may be configured to execute the different operations of the processor 502. The memory 504 may be further configured to store the target signals and corresponding profiles, amplitudes, and magnitudes. Example implementations of the memory 504 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 506 may include suitable logic, circuitry, interfaces, and/or code that may be configured to facilitate communication between the communication device 500 and the data transmission network 100. The network interface 506 may be implemented by use of various known technologies to support wired or wireless communication of the communication device 500 with the data transmission network 100. The network interface 506 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 506 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

It should be noted that the diagram of the communication device 500 in FIG. 5 is for exemplary purposes and should not be construed to limit the scope of the disclosure.

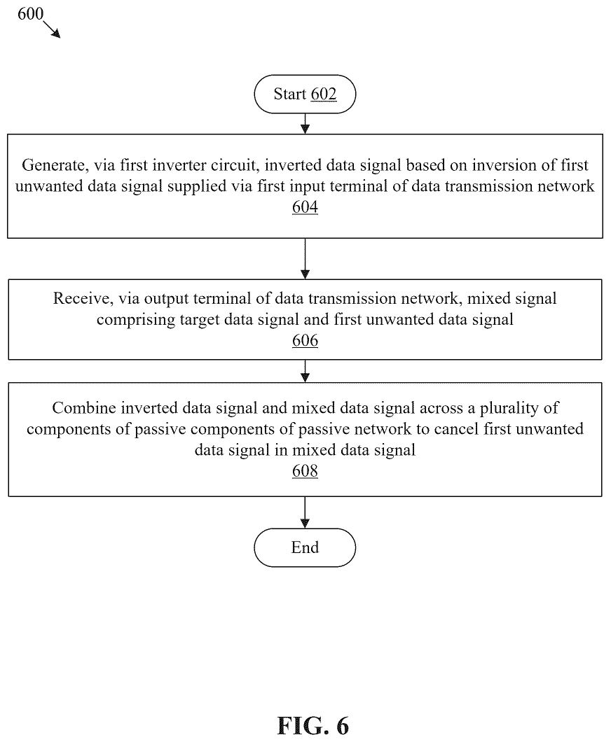

FIG. 6 illustrates a flowchart that illustrates a data cancellation method 600, in accordance with an embodiment of the disclosure. FIG. 6 is described in conjunction with elements from FIG. 1, FIG. 2A, FIG. 2B, FIG. 3, FIG. 4, and FIG. 5. With reference to FIG. 6, there is shown a flowchart for illustrating various steps of the data cancellation method 600. The data cancellation method 600 may include operations from 602 to 608 and may be implemented by the data canceler 110 of FIG. 1 or by the communication device 500 of FIG. 5. The data cancellation method 600 may start at 602 and proceed to 604.

At 604, an inverted data signal may be generated via a first inverter circuit 112. The inverted data signal may be based on an inversion of a first unwanted data signal supplied via a first input terminal 102 of a data transmission network 100. The first inverter circuit 112 may include the input terminal 114 coupled to the first input terminal 102 of the data transmission network 100.

At 606, a mixed data signal comprising a target data signal and the first unwanted data signal may be received via the output terminal 104 of the data transmission network 100.

At 608, the inverted data signal and the mixed data signal may be combined across the plurality of passive components 122 of the passive network 120 to cancel the first unwanted data signal in the mixed data signal. The plurality of passive components 122 of the passive network 120 may be arranged between the output terminal 104 of the data transmission network 100 and the output terminal 116 of the first inverter circuit 112. Control may pass to end.

Although the flowchart associated with the data cancellation method 600 is illustrated as discrete operations, such as, 604, 606, and 608, however the disclosure is not so limited. Accordingly, in certain embodiments, such discrete operations may be further divided into additional operations, combined into fewer operations, or eliminated, depending on the implementation without detracting from the essence of the disclosed embodiments.

A data canceler (for example, the data canceler 110 of FIG. 1) may include a first inverter circuit (for example, the first inverter circuit 112 of FIG. 1) having an input terminal 114 coupled to a first input terminal 102 of a data transmission network (for example, the data transmission network 100 of FIG. 1). The first inverter circuit 112 may be configured to generate a first inverted data signal based on an inversion of a first unwanted data signal supplied via the first input terminal 102. In an embodiment, the data canceler 110 may further include a passive network (for example, the passive network 120 of FIG. 1), which in turn includes a plurality of passive components (for example, the plurality of passive components 122 of FIG. 1) arranged between an output terminal 104 of the data transmission network 100 and an output terminal 116 of the first inverter circuit 112. The plurality of passive components 122 may include a first passive component and a second passive component, such that the first passive component is arranged between the output terminal 104 of the data transmission network 100 and the second passive component, and the second passive component is arranged between the first passive component and the output terminal 116 of the first inverter circuit 112. The passive network 120 may be configured to receive, via the output terminal 104 of the data transmission network 100, a mixed data signal including a target data signal and the first unwanted data signal. The passive network 120 may further be configured to combine the first inverted data signal and the mixed data signal across the plurality of passive components 122 to cancel the first unwanted data signal in the mixed data signal.

In an embodiment, the plurality of passive components 122 may include a first passive component (for example, the first passive component 122-1 of FIG. 1) and a second passive component (for example, the second passive component 122-1 of FIG. 1). The first passive component 122-1 may be arranged between the output terminal of the data transmission network 100 and the second passive component 122-2. The second passive component 122-2 may be arranged between the first passive component 122-1 and the output of the first inverter circuit 112.

In an embodiment, the cancellation of the first unwanted data signal in the mixed data signal may produce the target data signal across the second passive component 122-2.

In an embodiment, a ratio of resistance or capacitance values of the first passive component 122-1 to that of the second passive component 122-2 may be equal to a ratio of an amplitude of the mixed data signal to an amplitude of the first inverted data signal.

In an embodiment, a resistance of the first passive component 122-1 may be greater than an output impedance of the data canceler 110.

In one embodiment, each passive component of the plurality of passive components 122 may be a resistor or a capacitor.

In another embodiment, each passive component of the plurality of passive components 122 may be a variable resistor or a variable capacitor.

In an embodiment, the mixed signal may further include a second unwanted data signal.

In an embodiment, the data canceler 110 may further include a second inverter circuit, which may include an input coupled to a second input terminal of the data transmission network 100. The second inverter circuit may be configured to generate a second inverted data signal based on an inversion of the second unwanted data signal supplied via the second input terminal.

In an embodiment, the plurality of passive components 122 may include a third passive component arranged between an output terminal of the second inverter circuit and the first passive component 122-1 connected to the output terminal of the data transmission network 100.

In an embodiment, a canceler output swing voltage associated with the first inverter circuit 112 or the second inverter circuit 302 may be dependent on a voltage of a main driver of the data canceler 110.

While the present disclosure has been described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the particular embodiment disclosed, but that the present disclosure will include all embodiments that falls within the scope of the appended claims.

What is claimed is:

1. A data canceler, comprising:
a first inverter circuit comprising an input coupled to a first input terminal of a data transmission network,
wherein the first inverter circuit is configured to generate a first inverted data signal based on an inversion of a first unwanted data signal supplied via the first input terminal; and
a passive network comprising a plurality of passive components arranged between an output terminal of the data transmission network and an output of the first inverter circuit,
wherein the passive network is configured to:
receive, via the output terminal of the data transmission network, a mixed data signal comprising a target data signal and the first unwanted data signal; and
combine the first inverted data signal and the mixed data signal across the plurality of passive components to cancel the first unwanted data signal in the mixed data signal.

2. The data canceler according to claim 1, wherein the plurality of passive components includes a first passive component and a second passive component,
wherein the first passive component is arranged between the output terminal of the data transmission network and the second passive component, and
the second passive component is arranged between the first passive component and the output of the first inverter circuit.

3. The data canceler according to claim 2, wherein the cancellation of the first unwanted data signal in the mixed data signal produces the target data signal across the second passive component.

4. The data canceler according to claim 2, wherein a ratio of resistance or capacitance values of the first passive component to that of the second passive component is equal to a ratio of an amplitude of the mixed data signal to an amplitude of the first inverted data signal.

5. The data canceler according to claim 2, wherein a resistance of the first passive component is greater than an output impedance of the data canceler.

6. The data canceler according to claim 1, wherein each passive component of the plurality of passive components is a resistor or a capacitor.

7. The data canceler according to claim 1, wherein each passive component of the plurality of passive components is a variable resistor or a variable capacitor.

8. The data canceler according to claim 1, wherein the mixed data signal further comprises a second unwanted data signal.

9. The data canceler according to claim 8, further comprising:
a second inverter circuit comprising an input coupled to a second input terminal of the data transmission network,
wherein the second inverter circuit is configured to generate a second inverted data signal based on an inversion of the second unwanted data signal supplied via the second input terminal.

10. The data canceler according to claim 9, wherein the plurality of passive components comprises a third passive component arranged between an output of the second inverter circuit and a first passive component of the plurality of passive components connected to the output terminal of the data transmission network.

11. The data canceler according to claim 9, wherein a canceler output swing voltage associated with the first inverter circuit, or the second inverter circuit is dependent on a voltage of a main driver of the data canceler.

12. A communication device, comprising:
a data canceler that comprises:
a first inverter circuit comprising an input coupled to a first input terminal of a data transmission network,
wherein the first inverter circuit is configured to generate an inverted data signal based on an inversion of a first unwanted data signal supplied via the first input terminal; and
a passive network comprising a plurality of passive components arranged between an output terminal of the data transmission network and an output of the first inverter circuit,
wherein the passive network is configured to:
receive, via the output terminal of the data transmission network, a mixed data signal comprising a target data signal and the first unwanted data signal; and
combine the inverted data signal and the mixed data signal across the plurality of passive components to cancel the first unwanted data signal in the mixed data signal.

13. The communication device according to claim 12, wherein the plurality of passive components includes a first passive component and a second passive component,
wherein the first passive component is arranged between the output terminal of the data transmission network and the second passive component, and
the second passive component is arranged between the first passive component and the output of the first inverter circuit.

14. The communication device according to claim 13, wherein the cancellation of the first unwanted data signal in the mixed data signal produces the target data signal across the second passive component.

15. The communication device according to claim 13, wherein a ratio of resistance or capacitance values of the first passive component to that of the second passive component is equal to a ratio of an amplitude of the mixed data signal to an amplitude of the inverted data signal.

16. The communication device according to claim 13, wherein a resistance of the first passive component is greater than an output impedance of the data canceler.

17. The communication device according to claim 12, wherein each passive component of the plurality of passive components is a resistor or a capacitor.

18. The communication device according to claim 12, wherein each passive component of the plurality of passive components is a variable resistor or a variable capacitor.

19. The communication device according to claim 12, wherein the mixed data signal further comprises a second unwanted data signal.

20. A data cancellation method, comprising:
generating, via a first inverter circuit, an inverted data signal based on an inversion of a first unwanted data signal supplied via a first input terminal of a data transmission network,
wherein the first inverter circuit comprises an input coupled to the first input terminal of the data transmission network;
receiving, via an output terminal of the data transmission network, a mixed data signal comprising a target data signal and the first unwanted data signal; and
combining the inverted data signal and the mixed data signal across a plurality of passive components of a passive network to cancel the first unwanted data signal in the mixed data signal,
wherein the plurality of passive components of the passive network is arranged between the output terminal of the data transmission network and an output of the first inverter circuit.
